(19) United States
(12) Patent Application Publication
(10) Pub. No.: US 2005/0177076 A1
(43) Pub. Date: Aug. 11, 2005

(54) Rotating barrier for jet massage

(76) Inventor: Merlin E. Thomsen, Gresham, OR (US)

Correspondence Address: FSP LLC, 112 W 37TH ST., VANCOUVER, WA, 98660, US

(21) Appl. No.: 10/773,764

(22) Filed: Feb. 6, 2004

(51) Int. Cl. A61H 1/00; A61H 23/04; A61H 9/00

(52) U.S. Cl. 601/55; 601/61; 601/148

(57) ABSTRACT

A jet massage includes a pad and a moveable carriage having a rotating barrier enclosing water jets.

### TECHNICAL FIELD

The present disclosure relates to apparatus for water jet massage.

### BACKGROUND

Existing massage units include mechanical and electrical hand-held units that vibrate, pulsate and provide heat. Also known in the art are shower heads arranged to expel water in pulsating fashion whereby a person taking a shower is treated to a variety of sprays which can be physically directed at will to any desired spot on the body. Typical of this type are the devices disclosed in U.S. Pat. Nos. 3,762,648; 3,801,019; and 4,190,207.

A third type of prior massage unit is illustrated by U.S. Pat. Nos. 2,832,336 and 4,112,943. The latter patent discloses a device that provides heated water circulated to a flexible bag positioned on a person's back, for example. The action of the circulating water through the bag, and the heat emanating from the bag, serve to provide therapy to a muscle injury or the like.

U.S. Pat. Nos. 4,751,919, 4,908,016, 5,158,076 disclose a water jet massage apparatus including a platform having a bench mounted thereon, and an overlying lid arranged for pivotal movement between an open position in which a person may gain access to the bench and a closed position in which the lid is lowered onto the bench. The lid includes top, front, rear, and opposite side walls, and also has a bottom wall formed of flexible, water-proof material which drapes over and covers a person reclining on the bench when the lid is closed. The water-tight cavity in the lid defined by the aforementioned walls contains a laterally extending, longitudinally movable water manifold which mounts and supplies water to a plurality of pulsating water jet spray heads which direct a multitude of pulsating jets of water downward onto the flexible bottom wall which loosely covers a person reclining on the bench, keeping him dry. Spent water from the water jet heads finds its way to side gutters in the chamber whereupon the water drains from the water-tight cavity into a holding tank where it is reheated and recycled continuously. The effect is a multitude of pulsating massaging water jets impinging on the flexible material draped across the body, the spray head assembly also moving longitudinally through the chamber from head to toe or any desired portion thereof.

A disadvantage of the devices disclosed in U.S. Pat. Nos. 4,751,919, 4,908,016, 5,158,076 is that the person must recline under a closed lid, creating a claustrophobic effect. Also, the lid adds significant size and weight to the apparatus, making it more difficult to move and transport.

U.S. Pat. No. 6,428,466 discloses a massage with jets of water applying pressure to the body of the user. The jets are contained within a flexible enclosure to allow for a dry massage. The water jet enclosure closely contacts the body and is movable about the length of the spa to provide stimulation to most of the body. However, the water jet enclosure may be prone to snagging on contours, clothing, and adornments of the user.

### SUMMARY

The following summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the figures, and from the claims (which follow the detailed description).

A jet massage includes a frame and a carriage mounted to translate along the frame. A barrier enclosing water jets is coupled to rotate in conjunction with translation of the carriage. The water jets are located in a jet mount that passes through holes in discs to which the barrier is coupled.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a perspective illustration of an embodiment of a rotating barrier arrangement for a jet massage, with the barrier removed.

FIG. 2 is a perspective illustration of an embodiment of a rotating barrier arrangement for a jet massage, with the barrier attached.

FIG. 3 is a front view illustration of an embodiment of a rotating barrier arrangement for a jet massage.

FIG. 4 is a cut away illustration of an embodiment of a rotating barrier arrangement for a jet massage.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention. References to “one embodiment” or “an embodiment” do not necessarily refer to the same embodiment, although they may.

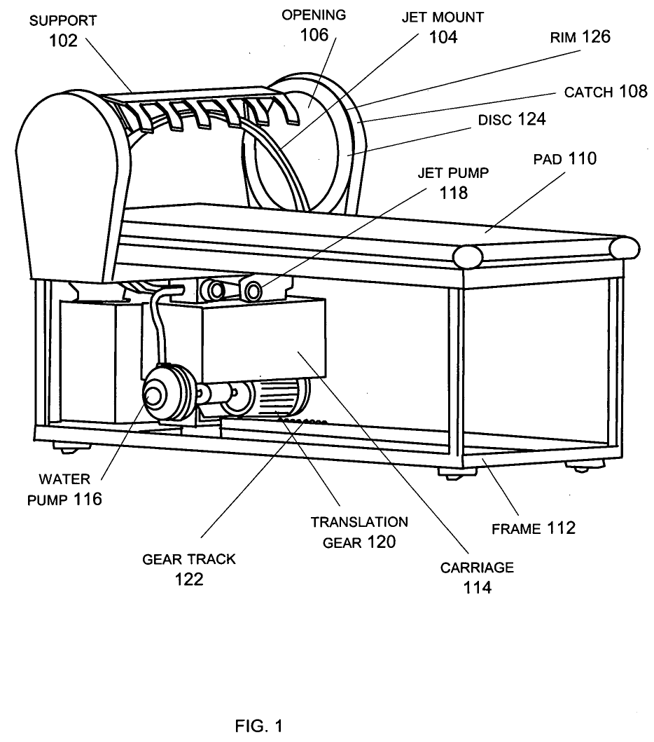

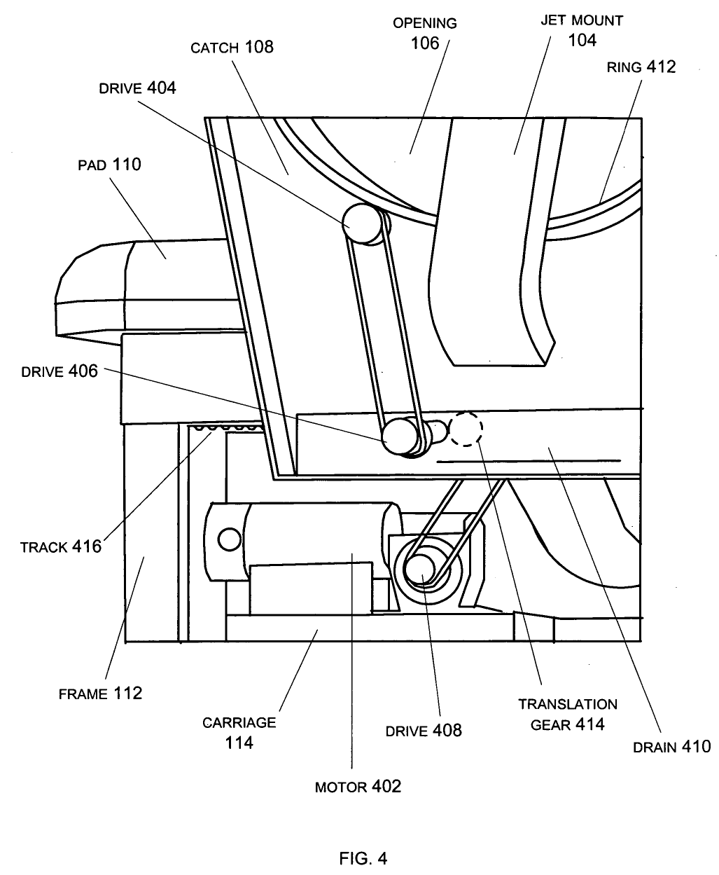

FIG. 1 is a perspective illustration of an embodiment of a rotating barrier arrangement for a jet massage, with the barrier removed. A rotating translation gear 120 engages a gear track 122 along a lower longitudinal member of a frame 112, causing a carriage 114 to translate along the frame 112. In other embodiments (e.g. FIG. 4) the gear track 122 may be located along an upper longitudinal member of the frame 112, or a linear actuator may be employed along with a smooth rotating rod to effect the translation and also provide a safety clutching mechanism.

The carriage 114 comprises catches 108, a barrier support 102, and a jet mount 104. Each catch 108 comprises a rotating disc 124 having an opening 106. The jet mount 104 passes through the openings 106. A water-tight barrier may be mounted along an outer rim 126 of the disc 124. As the carriage 114 translates along the frame 112, rotation of the discs 124 causes rotation of the barrier. The water pump 116 and jet pump 118 cooperate to supply water to jets mounted in the jet mount 104. The water is propelled out of the jets under significant pressure to provide massaging action to a person reclined on the pad 110. The water is stopped and collected by the barrier, which rotates over the form of the person, and is channeled to the sides of the pad 110, where the water is collected in the openings 106 of the catches 108.

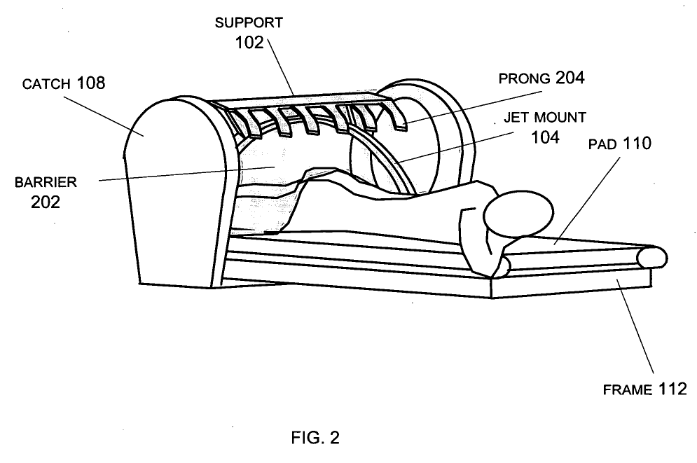

FIG. 2 is a perspective illustration of an embodiment of a rotating barrier arrangement for a jet massage, with the barrier attached. The carriage 114 comprises a barrier 202 that is a flexible membrane that deforms as it passes over the form of a person. The barrier 202 is coupled to the outer rims 126 of the discs 124 of the catches 108 of the carriage 114. As the carriage 114 translates along the frame 112, the discs 124 rotate, so that the barrier 202 rotates over the form of the person. Rotation of the barrier 202 alleviates snagging of the barrier on clothing, adornments, and contours of the person on the pad as the carriage 114 translates along the frame 112. The support 102 provides form and support to the barrier 202 and may be formed with prongs 204 to impart an approximately tubular shape to the barrier 202.

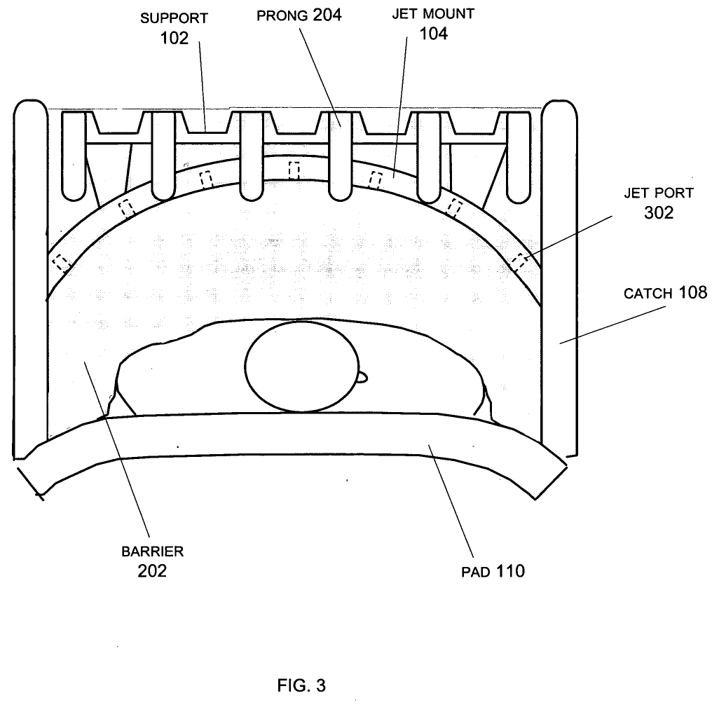

FIG. 3 is a front view illustration of an embodiment of a rotating barrier arrangement for a jet massage. The barrier 202 is supported by the support 102 and given form by the prongs 204. The support 102 is mounted on the jet mount 104. The jet mount 104 forms an arch between the openings 106 of the catches 108. Water is forced through jet ports 302 of the jet mount 104 to provide massage action to a person on the pad 110.

FIG. 4 is a cut away illustration of an embodiment of a rotating barrier arrangement for a jet massage. The carriage 114 comprises a motor 402 having a drive 408. The drive 408 may be a gear and gear belt arrangement, or a pulley and pulley belt arrangement, or other drive arrangement well known in the mechanical arts. Power from the drive 408 is delivered to a translation gear 414 having teeth that mate with the teeth of a gear track 416. Thus rotation of the drive 408 may cause the carriage 114 to translate along the frame 112. Of course, the gear track 416 could alternatively be located along a lower member of the frame 112, as depicted in FIG. 1. Pulleys, friction couplings, and/or linear actuators could also be employed to effect translation of the carriage 114 along the frame 112.

The translation gear 414 is coupled to a drive 406, which in turn is coupled to a drive 404. Various well-known mechanisms (e.g. gears, pulleys, etc.) may be employed to effect the drives 404, 406. The drive 404 turns a ring 412 of the disc 124 that rotates the barrier 202. The drive 404 may comprise a gear, and the ring 412 may comprise a ring gear. The drives 408, 406, 404, and the translation gear 414 may be selected in an approximately 1:1 ratio to provide sufficient rotation of the barrier 202 as the carriage 114 translates along the frame 112. Of course, other drive ratios may also be provided, depending on the proportion of rotation to translation desired.

Water enters the opening 106 of the catch 108 and falls to a drain 410, from which it is channeled back to the water pump 116. The jet mount 104 protrudes through the opening 106 and is secured to the catch 108 in a manner that does not interfere with the rotation of the ring 412.

An improved massage experience may thus be provided, wherein a moveable barrier may pass over a person reclined on a pad, and jet action within the barrier may provide the massaging action on the person without exposing the person to moisture. Rotation of the barrier alleviates snagging on clothing, limbs, adornments, and contours of the person's body.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

1. An apparatus comprising:
a frame;
a carriage mounted to translate along the frame;
water jets; and
a barrier enclosing the water jets and coupled to rotate in conjunction with translation of the carriage.

2. The apparatus of claim 1, further comprising:
a jet mount comprising the water jets and passing through holes in discs to which the barrier is coupled.

3. The apparatus of claim 2, further comprising:
a barrier support supported by the jet mount.

4. The apparatus of claim 2, further comprising:
holes located to collect water released from the water jets into the barrier.

5. An apparatus comprising:
a pad;
water jets; and
a barrier coupled to a carriage, the barrier enclosing the water jets and coupled to rotate in conjunction with translation of the carriage along the pad.

6. The apparatus of claim 5, further comprising:
a pair of catches to collect water from the water jets, the catches located on opposite sides of the pad from one another;
the catches comprising discs to which the barrier is coupled; and
the discs formed around holes located to collect water from the water jets.

7. The apparatus of claim 6, further comprising:
a jet mount comprising the water jets passing through the holes.

8. The apparatus of claim 7, further comprising:
a barrier support supported by the jet mount.

9. A jet massage comprising:
a pad;
a moveable carriage comprising a rotating barrier; and
water jets enclosed by the barrier.

10. The jet massage of claim 9, further comprising:
catches having holes located to collect water from the water jets as the water collects at the bottom of the barrier.

11. The jet massage of claim 10, further comprising:
a support formed to impart an approximately tubular shape to the barrier.

12. The jet massage of claim 10, further comprising:
the barrier coupled to discs formed around the holes.

13. An apparatus comprising:
a fluid-tight barrier;
an open table over which the fluid-tight barrier is mounted;
jets enclosed within the barrier; and
a control system to cause the jets to apply fluid under pressure to an interior surface of the barrier as the barrier is translated along the table.

14. The apparatus of claim 13, further comprising:
a control system to apply motion in addition to translation motion to the movable barrier as the movable barrier is translated over the table.

15. The apparatus of claim 13, further comprising:
a translation guide system for the barrier mounted below a surface of the table.

16. An apparatus comprising:
an open cushioned table unenclosed by a lid;
a water-tight barrier movably mounted over the open cushioned table; and
a control system to cause application of fluid under pressure to an interior surface of the barrier as the barrier is translated along and over the table.

17. The apparatus of claim 16, further comprising:
a control system to apply motion in addition to translation motion to the barrier as the barrier is translated over the table.

18. The apparatus of claim 16, further comprising:
a translation guide system for the barrier mounted below the table.
